(19) United States
(12) Patent Application Publication
(10) Pub. No.: US 2008/0077635 A1
(43) Pub. Date: Mar. 27, 2008

(54) Highly Available Clustered Storage Network

(75) Inventors: Manushantha Sporny, Blacksburg, VA (US); David D. Longley, Blacksburg, VA (US); Michael B. Johnson, Blacksburg, VA (US)

Correspondence Address: Manushantha Sporny, Suite 2408, 1700 Kraft Drive, Blacksburg, VA, 24060, US

(73) Assignee: DIGITAL BAZAAR, INC., Blacksburg, VA (US)

(21) Appl. No.: 11/839,904

(22) Filed: Aug. 16, 2007

Related U.S. Application Data
(60) Provisional application No. 60/826,606, filed on Sep. 22, 2006.

(51) Int. Cl. G06F 17/30

(52) U.S. Cl. 707/204; 707/E17.001

(57) ABSTRACT

A computing method and system is presented that allows multiple heterogeneous computing systems containing file storage mechanisms to work together in a peer-to-peer fashion to provide a fault-tolerant decentralized highly available clustered file system. The file system can be used by multiple heterogeneous systems to store and retrieve files. The system automatically ensures fault tolerance by storing files in multiple locations and requires hardly any configuration for a computing device to join the clustered file system. Most importantly, there is no central authority regarding meta-data storage, ensuring no single point of failure.

### FIELD OF THE INVENTION

This invention relates to the field of clustered computing storage systems and peer-to-peer networks. The disciplines are combined to provide a low-cost, highly available clustered storage system via a pure peer-to-peer network of computing devices.

### DESCRIPTION OF THE PRIOR ART

Network-based file systems have a history dating back to the earliest days of computer networking. These systems have always found a use when it is convenient to have data accessible via an ad-hoc or configured local-area network (LAN) or wide-area network (WAN). The earliest commercial standardization on these protocols and procedures came from Novell with their Netware product. This product allowed a company to access files from a Novell Netware Server and was very much a client/server solution. The work was launched in the early 1980s and gained further popularity throughout the 1990s.

Sun Microsystems launched their Network File System (NFS) in 1984 and was also a client-server based solution. Like Netware, it allowed a computing device to access a file system on a remote server and became the main method of accessing remote file systems on UNIX platforms. The NFS system is still in major use today among UNIX-based networks.

Windows CIFS/SMB/NetBIOS and Samba is another example of a client-server based solution. The result is the same as Netware and NFS, but more peer-to-peer aspects were introduced. These included the concept of a Workgroup and a set of computers in the Workgroup that could be accessed via a communications network.

The Andrew File System is another network-based file system with many things in common with NFS. The key features of the Andrew File System was the implementation of access control lists, volumes and cells. For performance, the Andrew File System allowed computers connecting to the file system the ability to operate in a disconnected fashion and sync back with the network at a later time.

The Global File System is another network-based file system that differs from the Andrew File System and related projects like Coda, and Intermezzo. The Global File System does not have disconnected operation, and requires all nodes to have direct concurrent access to the same shared block storage.

The Oracle Cluster File System is another distributed clustered file system solution in line with the Global File System.

The Lustre File System is a high-performance, large scale computing clustered file system. Lustre provides a file system that can handle tens of thousands of nodes with thousands of gigabytes of storage. The system does not compromise on speed or access permissions, but can be relatively difficult to setup. The system depends on metadata servers (MDS) to synchronize file access.

The Google File System is a proprietary file system that uses a master server and storage server nodes called chunk servers. The file system is built for fault tolerance and access speed. A file may be replicated as many as 3 times on the network or more for highly accessed files, ensuring a certain degree of fault tolerance.

There are a number of patents that contain similarities to the present invention, but do not provide the same level of functionality and services that the current invention provides. It is important to understand the differences in functionality that the current invention provides from other patents and publications currently being processed.

In U.S. Pat. No. 5,996,086, invented by Delaney et al. and assigned to LSI Logic, Inc., an invention is outlined that mentions that it provides node-level redundancy, but best mode is not provided regarding how to best accomplish node-level redundancy. Instead, the patent claims a method of providing fail-over services for computers connected to the same storage device. While useful, this approach requires the use of expensive hardware to provide fail-over while not guarding against the possibility of storage device failure. The present invention guards against storage device failure and node-level failure and outlines best mode for accomplishing both. Additionally, the present invention requires no prior configuration information is before fail-over services can be utilized, allowing the fail-over decision to be made by the client, not the server.

In U.S. Pat. No. 6,990,667, invented by Ulrich et al. and assigned to Adaptec, Inc., a rather complex distributed file storage system (DFSS) is proposed that covers various methods of mirroring metadata, file load balancing, and recovering from node and disk failure. U.S. Pat. No. 6,990,667 requires that metadata and configuration information is stored statically. Information such as server id, G-node information and file system statistics are not required, nor must they be orthogonal for the present invention to operate.

The present invention allows for the dynamic selection of the underlying file system—allowing new, more advanced, disk-based file systems to be used instead of the G-node-based file system listed by the Adaptec patent. The ability to choose underlying file systems dynamically allow the end-user to tune their disk-based file system independently of the network-based file system. Another important differentiator is the ease of implementation and operation when using the current invention. Due to the dynamic selection of underlying disk-based file system, the present invention reduces the complexity of implementing a high-availability, fault-tolerant file system. By reducing complexity, reliability and processing throughput is gained by the present invention.

Furthermore, U.S. Pat. No. 6,990,667 assumes that all data is of equal importance in their system. It is quite often that computing systems create temporary data, or cache data that is not important for long-term operation or file system reliability. The present invention takes a much more ad-hoc approach to the creation of a file system. A peer-to-peer based file system is ad-hoc in nature—allowing files to come into existence and dissipate from existence may be the desired method of operation for some systems utilizing the present invention. Thus, it is not necessary to ensure survival of every file in the file system, which is a requirement for the Adaptec patent.

U.S. Pat. No. 7,143,249, invented by Strange et al. and assigned to Network Appliance, Inc., focuses on rapid resynchronization of mirrored storage devices based upon snapshots and server co-located “plexes”. While rapid mirroring and mirror-recovery is important, the present invention does not rely on advanced mirroring concepts to increase performance. In one embodiment, the present invention uses a robust and simple synchronization mechanism called “rsync” to mirror data from one server to the next. Thus, methods of rapid mirroring are not of concern to the present invention, nor are methods of making disk-subsystems more reliable in a single enclosure. The goal of the present invention is to ensure data redundancy, when directly specified, by distributing metadata and file details to separate nodes with separate disk subsystems.

In U.S. Pat. No. 6,081,812, produced by Boggs et al. and assigned to NCR Corporation, a method to identify at-risk nodes and present them to a user in a graphical fashion is discussed. The present invention does not perform the extra step of at-risk prediction by checking path counts. All paths in the present invention utilize an N×N connectivity matrix. All online components of the system described in this document can message between each other eliminating the need to identify at-risk nodes. By eliminating the need to constantly check for at-risk nodes, the present invention is simplified. In US Patent Publication 2004/0049573 by Olmstead et al., the inventor focuses on establishing a method for automatically failing over a Standby Manager to the role of a Manager. The need for an efficient data distribution mechanism via a publish and subscribe model is also outlined. It is important to note that the present invention does not need any sort of centralized control, cluster manager or prior configuration information to start up and operate efficiently.

US Patent Publication 2005/0198238 by Sim et al. proposes a method for initializing a new node in a network. The publication focuses on distribution of content across geographically distant nodes. The present invention does not require any initialization when joining a network. The present invention also does not require any sort of topology traversal when addressing nodes in the network due to a guaranteed N×N connection matrix that ensures that all nodes may directly address all other nodes in a storage network. In general, while the 2005/0198238 publication may provide a more efficient method to distribute files to edge networks, it requires the operation of a centralized Distribution Center. The present invention does not require any such mechanism, thus providing increased system reliability and survivability in the event of a catastrophic failure of most of the network. While the Sim et al. publication would fail if there was permanent loss of the Distribution Center, the present invention would be able to continue to operate due to the nature of distributed meta-data and file storage.

### RELEVANT BACKGROUND

There are many different designs for computing file systems. The file systems that are relevant to this invention are network-based file systems, fault-tolerant file systems and distributed and/or clustered file systems.

Network file systems are primarily useful when one or more remote computing devices need to access the same information in an asynchronous or synchronous manner. These file systems are usually housed on a single file server and are stored and retrieved via a communication network. An example of network file systems are Sun Microsystems' Network File System and Windows CIFS utilizing the SMB protocol. The benefits of a network file system are centralized storage, management, and retrieval. The down-side to such a file system design is when the file server fails, all file-system clients on the network cannot read from or write to the network file system until the file server has recovered.

Fault-tolerant or high-availability storage systems are utilized to ensure that hardware failure does not result in failure to read from or write to the file storage device. This is most commonly supported by providing redundant hardware to ensure that single or multiple hardware failures do not result in unavailability. The simplest example of this type of storage mechanism for storage devices is RAID-1 (mirrored storage). RAID-1 keeps at least one hot-spare available such that, if a drive were to fail, another one, that is always kept in sync with the first disk, processes requests while the faulty disk is replaced. There are several other methods of providing RAID disk redundancy that each have advantages and disadvantages.

As file systems grow beyond single node installations, distributed and clustered file systems start to become more attractive because they provide storage that is several factors larger than single installation file systems. The Lustre file system is a good example of such a file system. These systems usually utilize between two to thousands of storage nodes. Access to the file system is either via a software library or via the operating system. Typically, all standard file methods are supported; create, read, write, copy, delete, updating access permissions and other meta-data modification methods exist. The storage nodes can either be stand-alone or redundant, operating much like RAID fault-tolerance to ensure high availability of the clustered file system. These file systems are usually managed by a single meta-data server or master server that arbitrates access requests to the storage nodes. Unfortunately, if this meta-data node goes down, access to the file system is unavailable until the meta-data node is restored.

While network file systems and fault-tolerant/high-availability file systems are required knowledge for this invention, the main focus of the invention is to support the third type of storage system described; the network accessible, clustered, distributed file system.

The invention, a highly-available, fault-tolerant peer-to-peer file system, is capable of supporting workload under massive failures to storage nodes. It is different from all other clustered file system solutions because it does not employ a central meta-data server to ensure concurrent access and meta-data storage information. The system also allows the arbitrary start-up and shutdown of nodes without massively affecting the file system while also allowing access and operation during partial failure.

### SUMMARY OF THE INVENTION

This invention comprises a method and system for the storage, retrieval, and management of digital data via a clustered, peer-to-peer, decentralized file system. The invention provides a highly available, fault-tolerant storage system that is highly scalable, auto-configuring, and that has very low management overhead.

In one aspect of the invention, a system is provided that consists of one or more storage nodes. A client node may connect to the storage node to save and retrieve data.

In another embodiment of the invention, a method is provided that enables a storage node to spontaneously join and spontaneously leave the clustered storage network.

In yet another embodiment of the invention, a method is provided that enables a client node to request storage of a file.

In another aspect of the invention, a method is provided that enables a client node to query a network of storage nodes for a particular data file.

In a further aspect of the invention, a method is provided that enables a client node to retrieve a specified file from a known storage node.

In yet another aspect of the invention, a method is provided that enables a client node to retrieve meta-data, file, or file system information for a particular storage node or multiple storage nodes.

In another aspect of the invention, a system is provided that enables a client node to cache previous queries.

In another aspect of the invention, a method is provided that enables a storage node to authenticate another node when performing modification procedures.

In yet a further aspect of the invention, a method is provided to allow voting across the clustered storage network.

A further aspect of the invention defines a method for automatic optimization of resource access by creating super-node servers to handle resources that are under heavy contention.

### BRIEF DESCRIPTION OF THE DRAWINGS

FIG. 1 is a system diagram of the various components of the fault-tolerant peer-to-peer file system.

FIG. 2a, FIG. 2b, and FIG. 2c are system diagrams of the various communication methods available to the secure peer-to-peer file system.

FIG. 3a is a flow diagram describing the process of a storage node notifying the clustered storage network that it is joining the clustered storage network.

FIG. 3b is a flow diagram describing the process of a storage node notifying it's departure from the clustered storage network.

FIG. 4 is a flow diagram describing the process of a client node requesting storage of a file from a network of storage nodes and then storing the file on a selected storage node.

FIG. 5 is a system diagram of a client node querying a network of storage nodes for a particular data file.

FIG. 6 is a flow diagram describing the process of a client node retrieving a file from a storage node.

FIG. 7 is a system diagram of a client querying a clustered storage network for various types of meta-data information.

FIG. 8 is a flow diagram describing the process of a node validating and authorizing communication with another node.

FIG. 9 is a flow diagram describing the process of modifying file data in such a way as to ensure data integrity.

FIG. 10 is a voting method to ensure proper resolution of resource contention and eviction of mis-behaving nodes on the clustered storage network.

FIG. 11 is a flow diagram describing the process of creating a super-node for efficient meta-data retrieval.

### DETAILED DESCRIPTION OF THE PREFERRED EMBODIMENTS

It is preferable to have a highly available, distributed, clustered file system that is infinitely expandable and fault-tolerant at the node level due to the high probability of single node failure as the size of the clustered file system grows. This means that as the file system grows, there can be no single point of failure in the file system design. It is preferable that all file system responsibilities are spread evenly throughout the fault-tolerant file system such that all but one node in the distributed file system can fail, yet the remaining node may still provide limited functionality for a client.

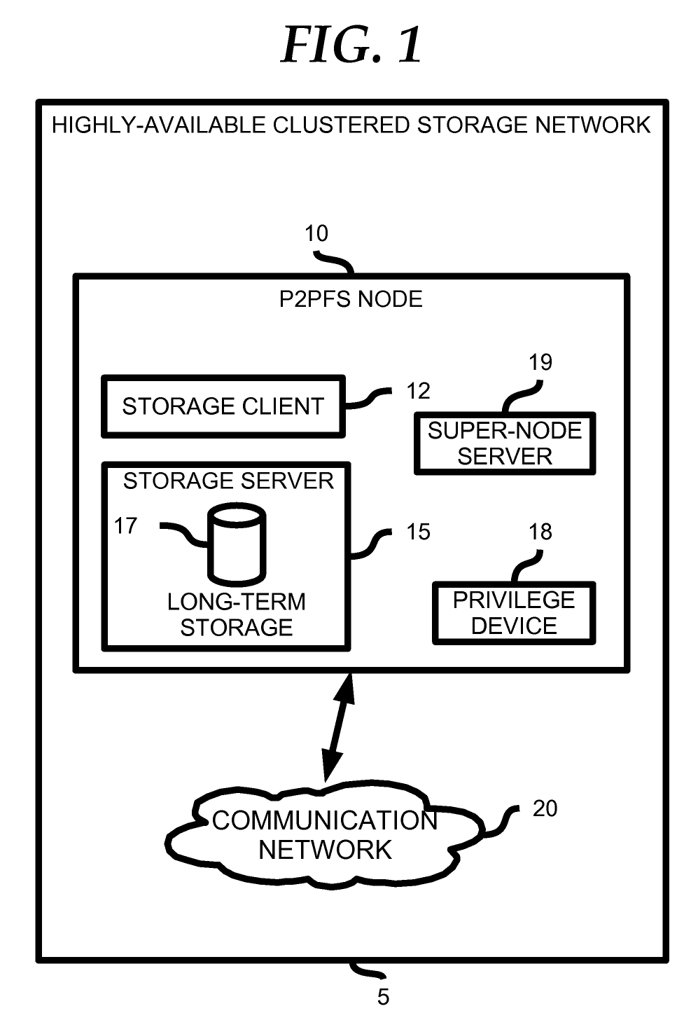

The clustered file system design is very simple, powerful, and extensible. The core of the file system is described in FIG. 1. The highly-available clustered storage network 5 is composed of two components in the simplest embodiment.

The first component is a peer-to-peer file system node 10 and it is capable of providing two services. The first of these services is a method of accessing the highly-available clustered storage network 5, referred to as a storage client 12. The storage client 12 access method could be via a software library, operating system virtual file system layer, user or system program, or other such interface device.

The second service that the peer-to-peer file system node 10 can provide, which is optional, is the ability to store files locally via a storage server 15. The storage server 15 uses a long-term storage device 17 to store data persistently on behalf of the highly-available clustered storage network 5. The long-term storage device 17 could be, but is not limited to, a hard disk drive, flash storage device, battery-backed RAM disk, magnetic tape, and/or DVD-R. The storage server 15, and accompanying long-term storage device 17 is optional, the node is not required to perform storage.

The peer-to-peer file system node 10 may also contain a privilege device 18 that is used to determine which operations can be performed on the node by another peer-to-peer file system node 10. The privilege device 18 can be in the form of permanently stored access privileges, access control lists, user-names and passwords, directory and file permissions, a public key infrastructure, and/or access and modification privilege determination algorithms. The privilege device 18, for example, is used to determine if a remote peer-to-peer file system node 10 should be able to read a particular file.

A peer-to-peer file system node 10 may also contain a super-node server 19 that is used to access distributed resources in a fast, and efficient manner. The super-node server 19, for example, can be used to speed access to meta-data information such as file data permissions, and resource locking and unlocking functionality.

A communication network 20 is also required for proper operation of the highly-available clustered storage network 5. The communication network may be any electronic communication device such as, but not limited to, a serial data connection, modem, Ethernet, Myrinet, data messaging bus (such as PCI or PCI-X), and or multiple types of these devices used in conjunction with one another. The primary purpose of the communication network 20 is to provide interconnectivity between each peer-to-peer file system node 10.

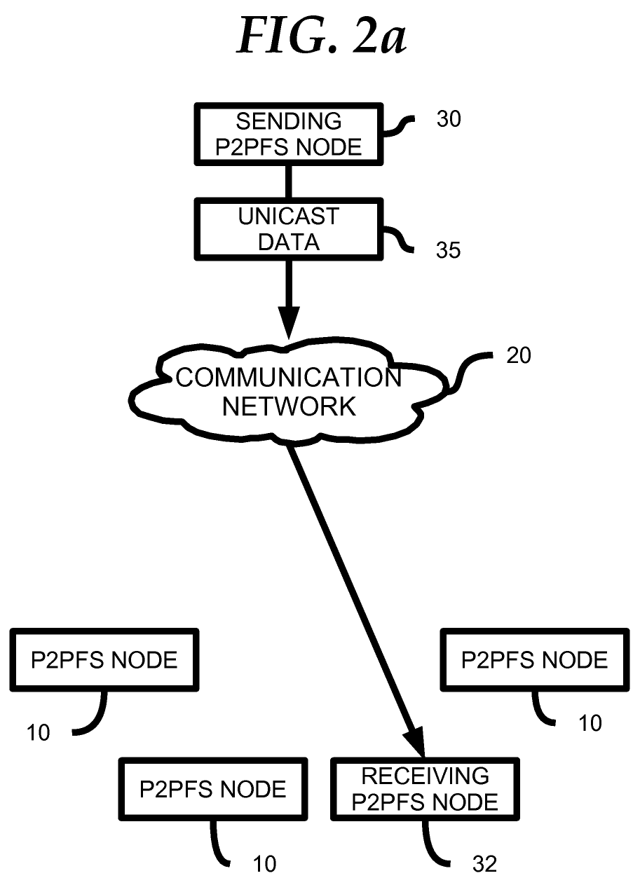

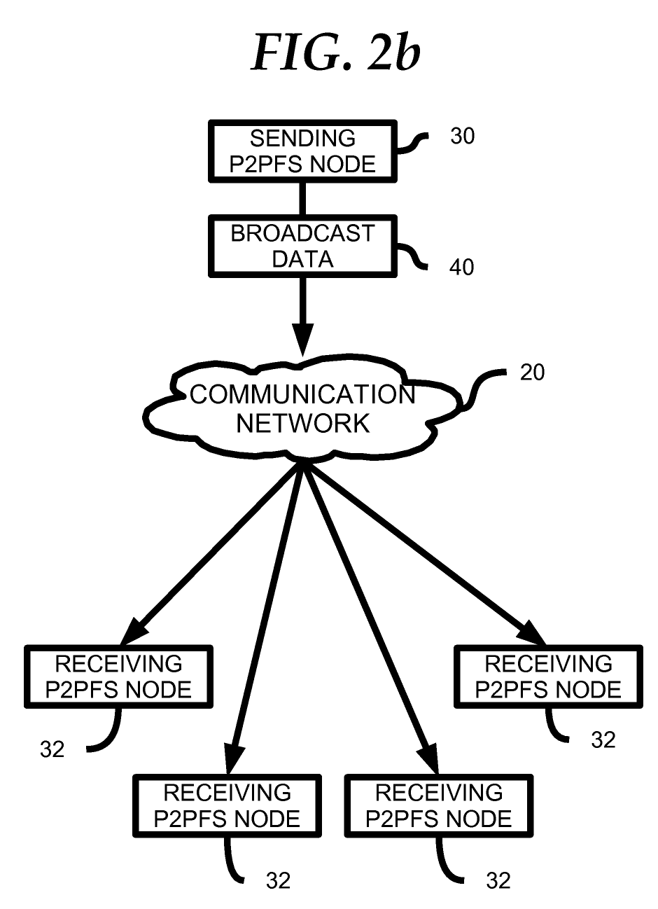

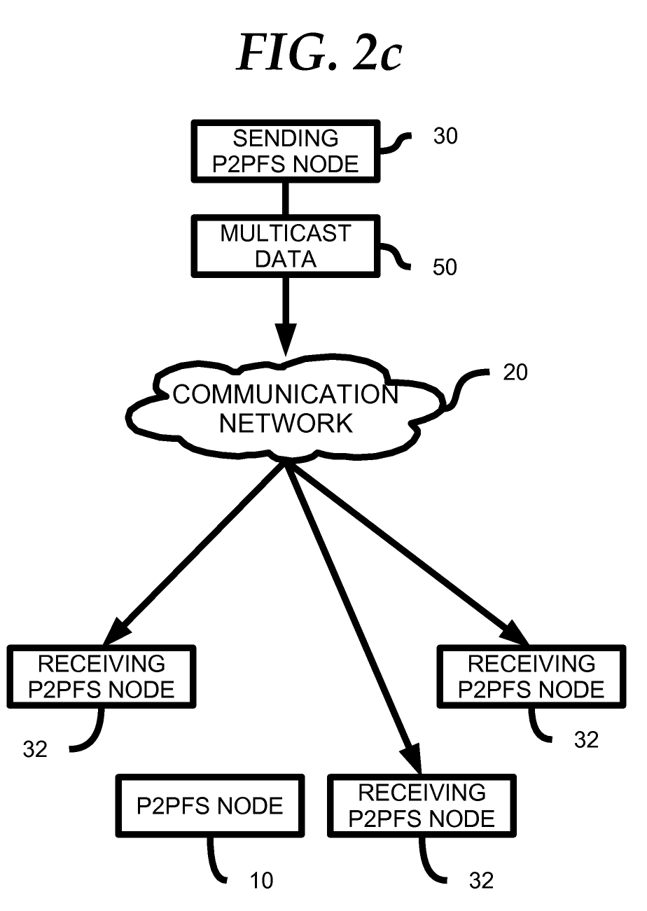

To ensure that the majority of data exchanged across the communication network 20 is used to transport file data, several communication methods are utilized to communicate effectively between nodes. The first of those communication methods, unicast data transmission, is outlined in FIG. 2a. Unicast data transmission is used whenever it is most efficient for a single sending peer-to-peer file system node 30 to communicate with single receiving peer-to-peer file system node 32. To perform this operation, unicast data 35 is created by the sending peer-to-peer file system node 30 and sent via the communication network 20 to the receiving peer-to-peer file system node 32. An example of this type of communication would be one or more Transmission Control Protocol (TCP) packets sent over the Internet Protocol (IP) via an Ethernet network to a single node.

FIG. 2b outlines the second highly-available clustered storage network 5 communication method, broadcast communication. In the broadcast communication scenario, a sending peer-to-peer file system node 30 desires to communicate with all nodes on a communications network 20. Broadcast data 40 is created and sent via the communication network 20 such that the data is received by all nodes connected to the communications network 20. An example of this type of communication would be one or more User Datagram Protocol (UDP) datagrams sent over the Internet Protocol (IP) via a Myrinet network.

The third type of communication scenario, outlined in FIG. 2c, involves sending data to a particular sub-set of nodes connected to a communication network 20. This type of method is called multicast communication and is useful when a particular sending peer-to-peer file system node 30 would like to communicate with more than one node connected to a communication network 20. To perform this method of communication, multicast data 50, is sent from the sending peer-to-peer file system node 30 to a group of receiving peer-to-peer file system nodes 32. An example of this type of communication is one or more multicast User Datagram Protocol (UDP) datagrams over the Internet Protocol (IP) addressed to a particular multicast address group connected to the Internet.

In both FIG. 2b and FIG. 2c, it is beneficial for any receiving peer-to-peer file system node 32 to contact the sending peer-to-peer file system node 30 and any sending peer-to-peer file system node 30 to contact the receiving peer-to-peer file system node 32. To enable bi-directional communication, a “reply to” address and communication port can be stored in the outgoing multicast data or broadcast data. This ensures that any request can be replied to without the need to keep contact information for any fault-tolerant peer-to-peer node 10.

In FIG. 2a, FIG. 2b and FIG. 2c, it is beneficial for all participants in the highly-available clustered storage network 5 to be able to subscribe to events related to storage network activity. In general, the use of a multicast communication method is the most efficient method in which broad events related to storage network activity can be published. The type and frequency of event publishing vary greatly, events such as file creation, file modification, file deletion, metadata modification, peer-to-peer file system node 10 join notifications and leave notifications are just a few of the events that may be published to the storage network event multicast or broadcast address. Unicast event notification is useful between partnered storage nodes when modification, locking and synchronization events must be delivered.

In this document, for the purposes of explanation, whenever it is stated that a peer-to-peer file system node 10 is communicating using methods stated in FIG. 2a, FIG. 2b or FIG. 2c it is generalized that any component contained by the peer-to-peer file system node 10 may be performing the communication. For example, if a statement to the effect of “then the peer-to-peer file system node 10 sends multicast data to a receiving peer-to-peer file system node 30”, it has been generalized that any component in the peer-to-peer file system node 10 can be communicating with any component in the receiving peer-to-peer file system node 30. These components can include, but are not limited to; the storage client 12, storage server 15, long-term storage device 17, privilege device 18 or super-node server 19. In general, the component most suited to perform the communication is used on the sending and receiving node.

The main purpose of the highly-available clustered storage network 5 is to provide fault-tolerant storage for a storage client 12. This means that at least one peer-to-peer file system storage node must be available via the communication network 20 to store files and support file processing requests. One fault-tolerant peer-to-peer storage client 12 must be available via the communication network 20 to retrieve files. The storage client 12 and node may be housed on the same hardware device. If the system is to be fault-tolerant, at least two fault-tolerant peer-to-peer nodes must exist via the communication network 20, the first fault-tolerant peer-to-peer node 10 must contain at least as much storage capacity via a long term storage device 17 as the second fault-tolerant peer-to-peer node 10.

To ensure data integrity in a fault-tolerant system, file system modifications are monitored closely and at least two separate nodes house the same data file at all times. When two nodes house the same data, these nodes are called partnered storage nodes. Multiple reads are allowed, however, multiple concurrent writes to the same area of a file are not allowed. When file information is updated on one storage node, the changes must be propagated to other partnered storage nodes. If a partnered storage node becomes out of sync with the latest file data, it must update the file data before servicing any storage client 12 connections.

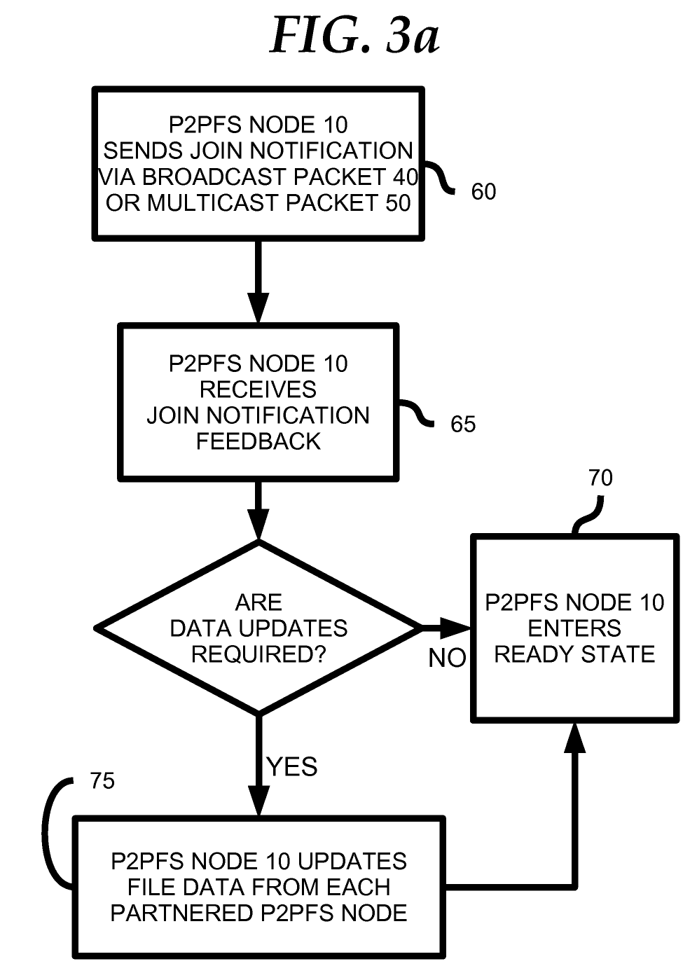

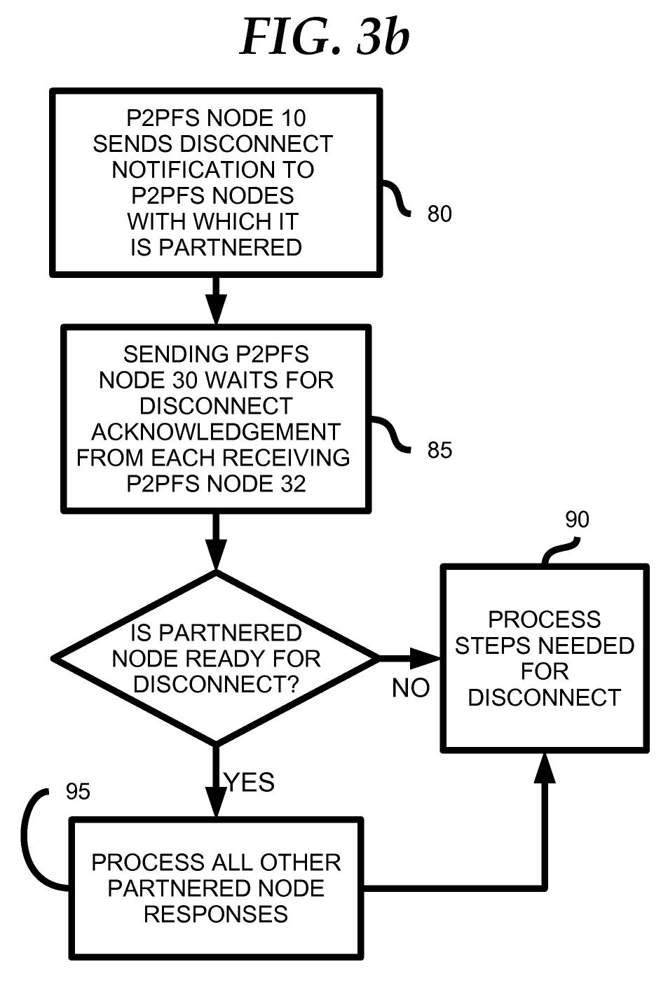

Joining and leaving a highly-available clustered storage network 5 is a simple task. Certain measures can be followed to ensure proper connection to and disconnection from the highly-available clustered storage network 5. As FIG. 3a illustrates, a fault-tolerant peer-to-peer node 10 can join a highly-available clustered storage network 5 by following several simple steps.

In step 60, a fault-tolerant peer-to-peer node 10 that is available to store data notifies nodes via a communication network 20 by constructing either broadcast data 40 or multicast data 50 and sending it to the intended nodes. The data contains at least the storage node identifier and the storage file system identifier. The data is a signal to any receiving fault-tolerant peer-to-peer node 32 that there is another storage peer joining the network. Any receiving fault-tolerant peer-to-peer node 32 may choose to contact the sending fault-tolerant peer-to-peer node 30 and start initiating storage requests.

The next step of the clustered storage network join process is outlined in step 65. After the sending fault-tolerant peer-to-peer node 30 has notified the receiving fault-tolerant peer-to-peer nodes 32, the receiving nodes may reply by sending back a simple acknowledgment of the join notification. The receiving nodes may also start performing storage requests of any kind on the sending fault-tolerant peer-to-peer node 30. Typically, the only storage request that a sending fault-tolerant peer-to-peer node 30 will have to service directly after joining a clustered storage network is a plurality of file synchronization operations.

If there are no file synchronization operations that need to be completed, the sending fault-tolerant peer-to-peer node 30 enters the ready state and awaits processing requests from storage clients 12 as shown in step 70.

When fault-tolerant peer-to-peer nodes 10 operate in a clustered storage network, each node peers with another to ensure node-based redundancy. Therefore, if one node fails, a second node always contains the data of the first node and can provide that data on behalf of the first node. When the first node returns to the clustered storage network, some data files may have been changed during the first node's absence. The second node, upon the first node re-joining the network, will notify the first node to re-synchronize a particular set of data files.

The process of synchronizing data files between an up-to-date node, having the data files, and an out-of-date node having an out-of-date version of the data files is referred to in step 75. There are several ways in which the present invention can perform these synchronizations.

Each method requires the up-to-date node to send a synchronization request along with the list of files that it is storing. Each file should an identifier associated with it. Examples of identifiers are: a checksum, such as an MD5 or SHA-1 hash of the file contents, a last-modified time-stamp, a transaction log index, or a transaction log position. Two possible synchronization methods are listed below.

The first method of synchronization is for the out-of-date node to check each file checksum listed by the up-to-date node. If an out-of-date node file checksum differs from the up-to-date node and the file modification time-stamp is newer on the up-to-date node, the entire file is copied from the up-to-date node to the out-of-date node. If an out-of-date node file checksum differs from the up-to-date node and the file modification time-stamp is older on the up-to-date node, the entire file is copied from the out-of-date node to the up-to-date node.

The second method of file synchronization is identical to the first method, except in how the file is copied. Each large file on the storage network has a journal associated with the file. An example of an existing system that uses a journal is the EXT3 or ReiserFS file system. A journal records all modification operations performed on a particular file such that if two files are identical, the journal can be replayed from beginning to end to modify the files such that each file will be identical after the modifications are applied. This is the same process that file patch-sets and file version control systems utilize.

When a file is newly created on the clustered network storage system, a journal position is associated with the file. For incredibly large files with small changes, a journal becomes necessary to efficiently push or pull changes to other partnered nodes in the clustered storage network. If a journal is available for a particular file that is out of date, the journal position is sent from the out-of-date node. If a journal can be constructed from the up-to-date node's file journal from the position given by the out-of-date node's file journal, then the journal is replayed via the communication network 20 to the out-of-date node until both file journal positions match and both file checksums match. When the journal positions and the file checksums match, each file is up-to-date with the other.

Standard operation of the fault-tolerant, peer-to-peer node 10 continues until it is ready to leave the clustered storage network. There are three main methods of disconnecting from the clustered storage network that the invention outlines. They are permanent disconnection, temporary disconnection and unexpected disconnection. The method of leaving the clustered storage network is outlined in FIG. 3b.

Unexpected disconnection is inevitable as the number of fault-tolerant, peer-to-peer nodes 10 grow. The most common expected cause of such operations are both network device failure, storage sub-system failure, and power system failure. This system is aware of this as an inevitability and quickly ensures that any data that should be duplicated due to a fault-tolerant, peer-to-peer node 10 failure is accomplished within the operating parameters of the clustered storage network.

For permanent and temporary disconnection, as shown in step 85, the sending fault-tolerant, peer-to-peer node 30, also known as the disconnecting node, sends unicast or multicast data to each server with which it is partnered. The receiving fault-tolerant, peer-to-peer node 32, also known as the partnered node, is responsible for sending an acknowledgment that disconnection can proceed or a reply stating that certain functions should be carried out before a disconnection can proceed in step 90.

In the case of temporary disconnection, the disconnecting node encapsulates the amount of time that it expects to be disconnected from the network in the unicast or multicast data message. The partnered node can then process any synchronization requests that are needed before the disconnecting node leaves the network. The partnered node may also decide that the amount of time that the disconnecting node is going to be unavailable is not conducive to proper operation of the clustered storage network and partner with another fault-tolerant, peer-to-peer node 10 for the purposes of providing data redundancy.

The process required by step 90 may include file synchronization. A disconnecting node may need to update partner nodes before disconnecting from a clustered storage network. The details of file synchronization was covered earlier in the document when discussing step 75.

In the case of permanent disconnection, all data that has not yet been redundantly stored on a partnered node must be updated via the file synchronization process discussed in step 75 before the permanent disconnection of the disconnecting node.

Once all operations required by a partner node have been completed, the partner node acknowledges the disconnection notification by the disconnecting node. The disconnecting node then processes the rest of the partnered node responses as shown in step 95. This process continues until all partnered nodes have no further operations required of the disconnecting node and have acknowledged the disconnection notification. Any other relevant disconnection operations are processed and the disconnecting node leaves the clustered storage network.

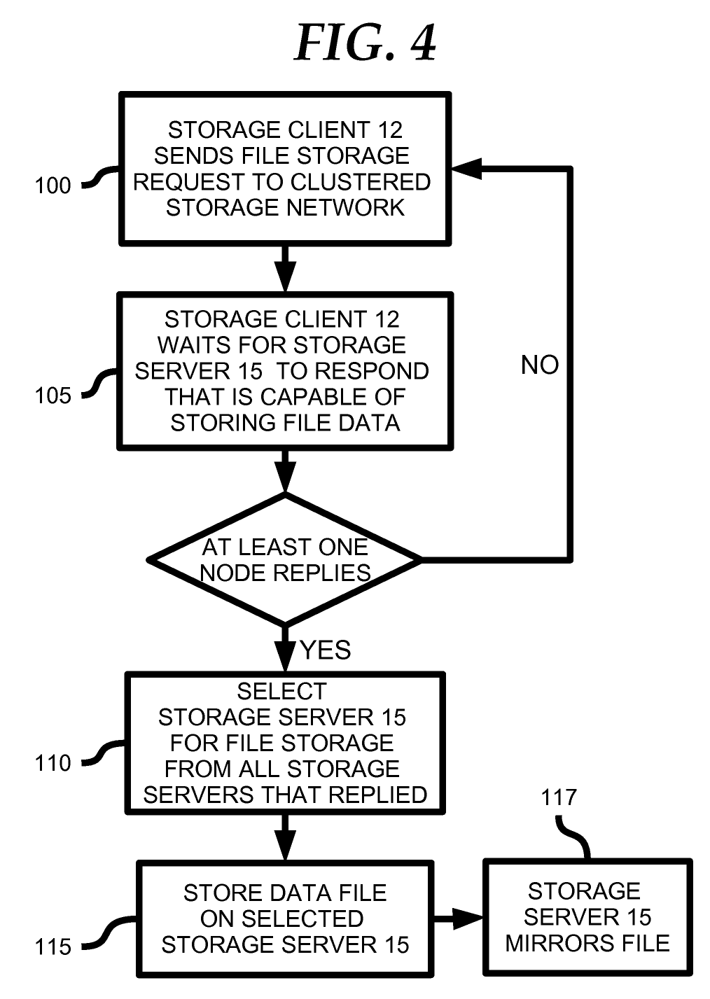

Storing files to the clustered storage network is a relatively simple operation outlined in FIG. 4. A storage client 12, described as any method of accessing the highly-available clustered storage network 5, sends a file storage request to the clustered storage network as outlined in step 100. This request may be performed in any of the methods outlined in the communication FIG. 3a, 3b or 3c. Ideally, this request would be sent via a multicast message to all storage server 15 services. The storage request may optionally contain information about the file being stored, guaranteed connection speed requirements, frequency of access and expected file size.

The storage client 12 then waits for replies from receiving fault-tolerant peer-to-peer nodes 32 as shown in step 105. Processing on the storage server 15, upon receiving a file storage request, first attempts to see if a given file exists on the storage server. If the data file already exists, then a response is sent to the storage client 12 notifying it that a file with the given identifier or path name already exists but storage can proceed if the storage client 12 requests to overwrite the preexisting data file. This is used as a mechanism to notify the storage client 12 that the file can be stored on the storage server 15, but a file with that name already exists. The storage client 12 can decide to overwrite the file or choose a different file name for the data file.

If the storage server 15 is capable of housing the data file, based on any optional usage information that the storage client 12 sent in the request, the storage server 15 replies with a storage acceptance message. The storage acceptance message may contain optional information such as amount of free space on the file system, whether the file data will be overwritten if it already exists, or other service level information such as available network bandwidth to the storage server or storage server processing load. If the storage server 15 is not capable of storing the file for any reason, it does not send a reply back to the storage client 12.

The storage client 12 collects replies from each responding storage server 15. If the storage client 12 receives a “file already exists” response from any storage server 15, then storage client 12 must determine whether or not to overwrite the file. A notification to the user that the file already exists is desired, but not necessary. The storage client 12 can decide at any time to select a storage server 15 for storage and continue to step 110. If there are no responses from available storage server 15 nodes, then the storage request can be made again, returning the file storage process to step 100.

In step 110, the storage client 12 must choose a storage server 15 from the list of storage servers that replied to the storage request. It is ultimately up to the storage client 12 to decide which storage server 15 to utilize for the final file storage request. The selection process is dependent on the needs of the storage client 12. If the storage client 12 desires to choose a storage server 15 that contains the greatest amount of available storage on the storage server 15 long term storage 17 device, then the storage client 12 would choose a storage server 15 with the greatest amount of available storage capacity. If the storage client 12 desired a fast connection speed, it would choose a storage server 15 that fit the matching criteria. While these are just two examples of storage server 15 selection, many more parameters exist when deciding what type of selection criteria matter for a particular storage client 12. Once a storage server 15 has been chosen by the storage client 12, the storage server 15 is contacted via a unicast communication method as described in step 115.

In another embodiment of the invention, step 110 proceeds as outlined in the previous paragraph, but more than one storage server 15 can be chosen to house different parts of a data file. This is desired whenever a single file may be far too large for any one storage server 15 to store. For example, if there are twenty storage server 15 nodes, and each can store one terabyte of information and a storage client would like to store a file that is five terabytes in size, then the file could be split into one terabyte chunks and stored across several storage nodes.

The process in step 115 consists of the storage client 12 contacting one or more storage server 15 nodes and performing a file storage commit request. The storage client 12 sends unicast data 35 to the storage server 15 explaining that it is going to store a file, or part of a file, on the storage server 15. The storage server 15 can then respond with an acknowledgment to proceed, or a storage commit request denial.

A storage commit request denial occurs when the storage server 15 determines that a file, or part of a file, cannot or should not be stored on the storage server 15. These reasons could be that a file with the given identifier or file path is already stored elsewhere and this storage server 15 is not the authority on that file, the storage server 15 cannot support the quality of service desired by the storage client 12, the storage client 12 does not have permission to create files on the storage server 15, or that the amount of storage required by the data file is not available on the particular storage server 15. There are many other reasons that a file storage request could be denied and the previously described list should not be construed as an exhaustive explanation of these reasons.

A file storage commit request sent by the storage client 12 is followed by a file storage commit request acknowledgment by the storage server 15. When the storage client 12 receives the acknowledgment, it sends the data to the storage server 15 via the communication network 20 and the data file, in part or as a whole, is then committed to the storage server 15 long term storage 17.

The storage server 15 can optionally attempt to ensure data redundancy after it has received the complete file from the storage client 12 by mirroring the file on another storage server 15 as shown in step 117. To perform this operation, the storage server 15 sends a mirror request to current partnered nodes via a unit-cast data message, or all of the storage server 15 nodes via either a broadcast or multicast data message via the communication network 20. The process closely follows steps 100, 105 and 110, but in place of the storage client 12, the storage server 15 is the entity making the requests.

After the mirroring request is made by the storage server 15, a list of available storage server 15 nodes is collected and a target storage server 15, also known as a partner node, is selected. This selection is performed in very much the same way as step 110, with one additional method of choosing a proper storage server 15. To ensure minimal network traffic and minimal long-term network link creation, a pre-existing partnered node may be selected to perform the mirroring storage commit request if it is known that such a partnered node will be able to store the data file in part or as a whole.

The process of synchronizing the file between partnered nodes, in this case being both storage server 15 nodes, can be the same as the one described in step 115 or previously in step 75. Once the data file redundancy has been verified, all partnered nodes can accept further clustered storage network operations.

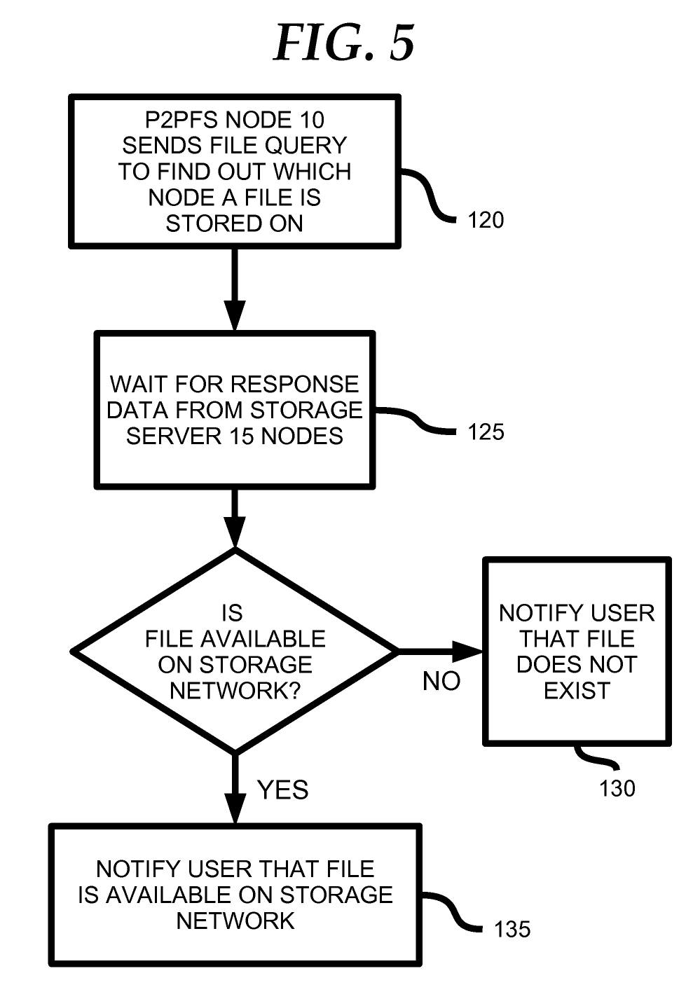

FIG. 5 outlines the processes needed to determine whether a file is available on the highly-available clustered storage network 5. In step 120, a fault-tolerant peer-to-peer file system node 10 sends a broadcast or multicast message to storage server 15 nodes via the communication network 20. The message contains a file status request.

In step 125, the message is received by storage server 15 nodes, if the node contains the most up-to-date version of the file, the storage server 15 replies with the current information regarding the file. This information can contain, but is not limited to, file size, modification time-stamp, journal position, file permissions, group permissions, access control list information, file meta-data, and other information pertinent to the file data.

If there is no response for a specified amount of time, for example 5 seconds, then the storage client 12 notifies the user that the file data does not exist in step 130. The user can be a computing device, program, or human being using the storage client 12 through a human-machine interface such as a computer terminal.

If at least one storage server 15 replies with a message stating that the file exists, then the storage client 12 notifies the user that the file data does exist in step 135. The user can be a computing device, program, or human being using the storage client 12 through a human-machine interface such as a computer terminal.

The process in FIG. 5 is useful when querying the network for data file existence. This is useful when creating a new file on the clustered storage network or when attempting to retrieve a file from the highly-available clustered storage network 5.

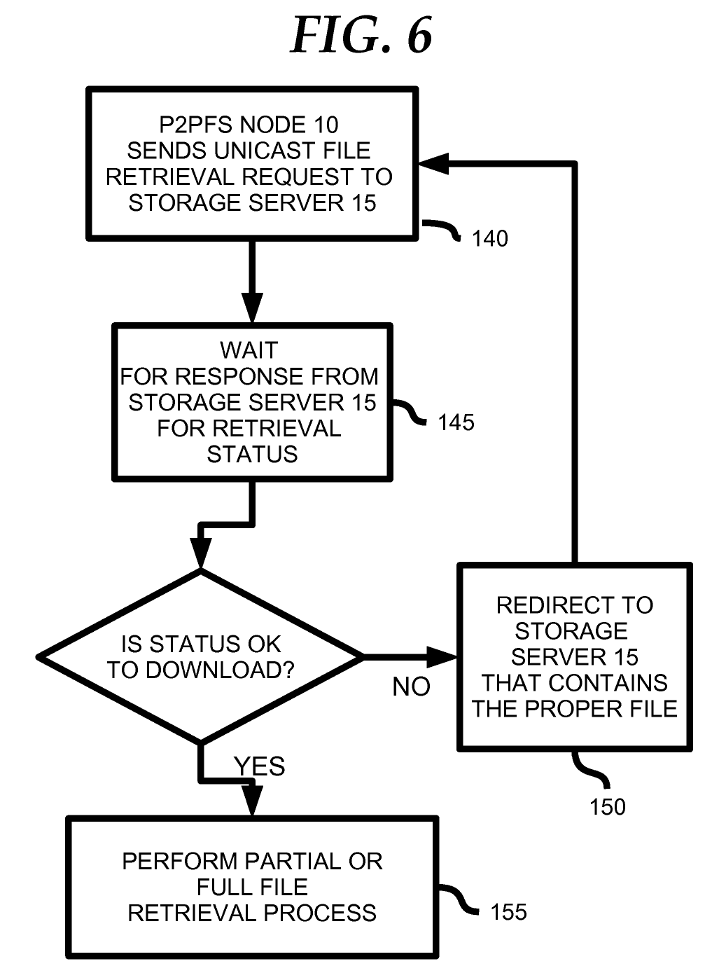

FIG. 6 outlines the process of retrieving a data file from the highly-available clustered storage network 5. It is assumed that the fault-tolerant peer-to-peer file system node 10 has knowledge of the storage server 15 location of a data file when starting this process. One method of discovering the location of a particular data file is via the process described in FIG. 5. In step 140, the fault-tolerant peer-to-peer file system node 10 contacts the storage server 15 directly via a unicast communication method with a file retrieval request.

In step 145, the fault-tolerant peer-to-peer file system node 10 then waits for a reply from the storage server 15. The storage server 15 must ensure proper access to the file such that data that is out-of-date or corrupt is not sent to the requesting node. For example, if the storage server 15 determines that the current data file stored is out-of-date, or is being synchronized to a up-to-date version on a partnered storage server 15, and that the partnered storage server 15 contains the up-to-date file data, the requesting node is notified that the up-to-date data resides on another storage server 15 in described in step 150.

In step 150, if the up-to-date file is stored on a partnered storage server 15, then the fault-tolerant peer-to-peer file system node 10 contacts the location of the up-to-date file and starts again at step 140.

In step 155, if the storage server 15 determines that the data file is up-to-date and is accessible, then the requesting fault-tolerant peer-to-peer file system node 10 is notified that it may perform a partial download or a full download of the file. The requesting fault-tolerant peer-to-peer file system node 10 may then completely download and store the file, or stream parts of the file. The file data may also be streamed from multiple up-to-date file locations throughout the clustered file system to increase read throughput. This method is popular in most peer-to-peer download clients, such as BitTorrent.

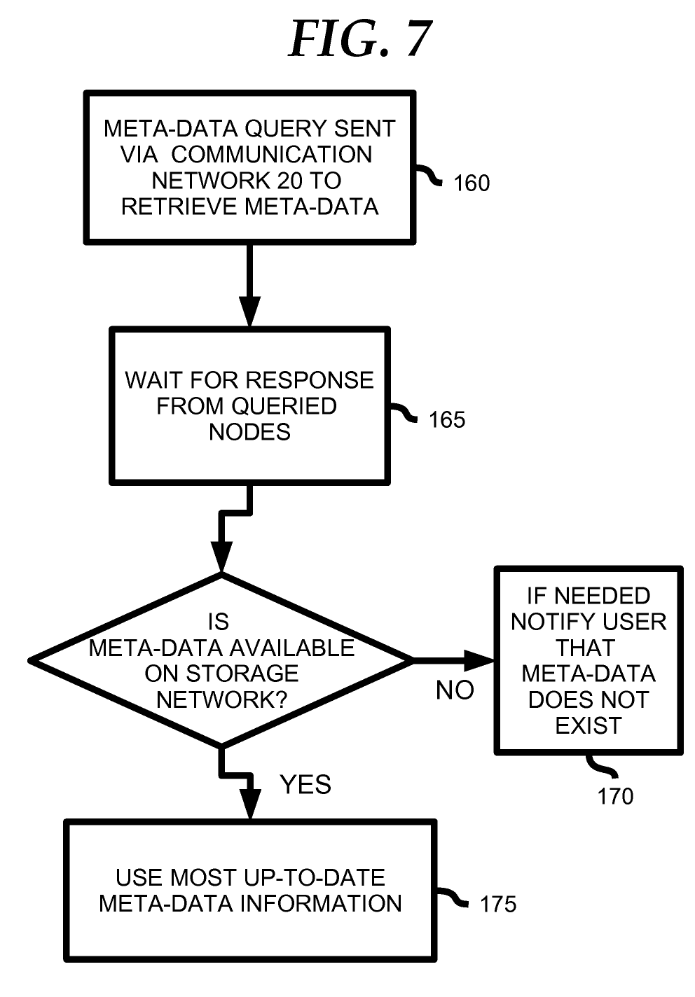

FIG. 7 outlines the method of querying the highly-available clustered storage network 5 for meta-data information. Meta-data information is classified as any data, data file, or system that is operational within the highly-available clustered storage network 5. Some examples include, but are not limited to, file system size, file system available storage, data file size, access permissions, modification permissions, access control lists, storage server 15 processor and/or disk load status, fault-tolerant peer-to-peer file system node 10 availability and status, and other clustered storage network related information.

These queries can be performed, as shown in step 160, using a unicast, broadcast, or multicast communication method. Ideally, a multicast method is used for meta-data requests regarding all storage server 15 nodes on the network. Broadcast meta-data requests are only used when it is the most efficient method of communication, such as determining the available storage volumes or partitions in the clustered storage network. Unicast meta-data requests are used if information is only needed from one fault-tolerant peer-to-peer file system node 10, or a very small subset of peer-to-peer file system nodes. The specific meta-data query is placed in the outgoing message and sent to the queried node or nodes via the most efficient communication method available.

Following on to step 165, the requesting fault-tolerant peer-to-peer file system node 10 waits for at least one response from the queried nodes. If there is no response for a specified amount of time, for example 5 seconds, then the requesting fault-tolerant peer-to-peer file system node 10 notifies the user that the meta-data does not exist in step 170. The user can be a computing device, program, or human being using the fault-tolerant peer-to-peer file system node 10 through a human-machine interface such as a computer terminal.

If the meta-data request is replied to by one or more fault-tolerant peer-to-peer file system nodes 10, step 175 is performed. The requesting node tabulates the information, decides which piece of information is the most up-to-date and utilizes the information for processing tasks. One of those processing tasks may be notifying the user of the meta-data information. The user can be a computing device, program, or human being using the fault-tolerant peer-to-peer file system node 10 through a human-machine interface such as a computer terminal.

For example, a multicast meta-data request would be performed if a fault-tolerant peer-to-peer file system node 10 desired to know the total available storage space available via the clustered storage network. A multicast meta-data request would go out regarding total space available to every storage server 15, and each would reply with the current amount of available space on each respective local file system. The fault-tolerant peer-to-peer file system node 10 would then tally all the amounts together and know the total available space on the highly-available clustered storage network 5. If the fault-tolerant peer-to-peer file system node 10 only desired to know the available storage space for one storage server 15, it would perform the meta-data request via a unicast communications channel with the storage server 15 in question.

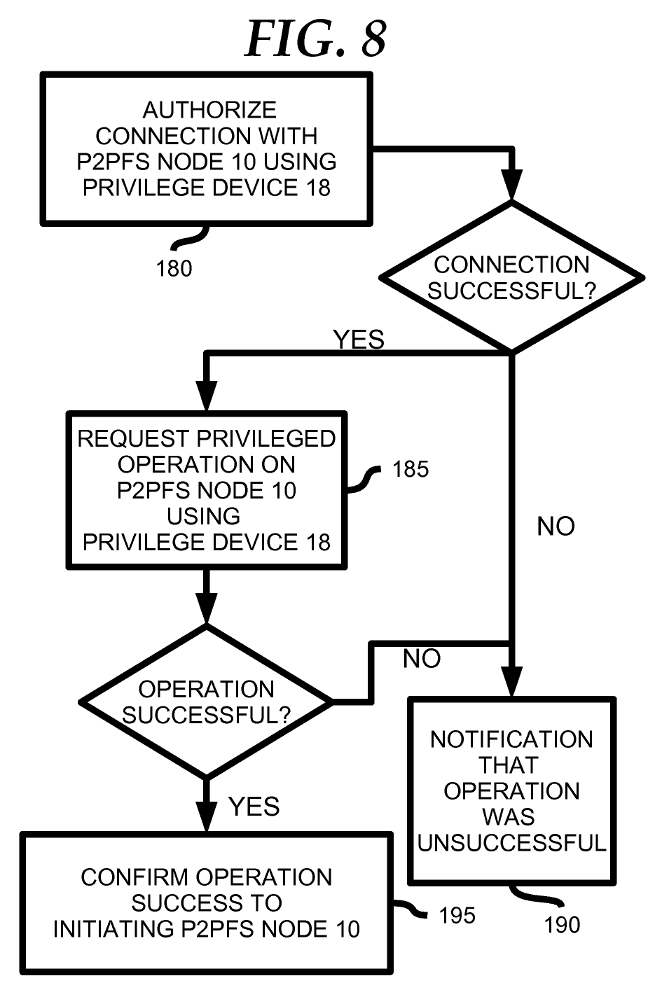

FIG. 8 describes a method to authorize remote requests on a receiving peer-to-peer file system node 10. This method is applicable to any peer-to-peer operation described in the present invention, including but not limited to; clustered storage network join and leave notifications, synchronization requests and notifications, file storage, query, modification and retrieval requests, meta-data query, modification and retrieval requests and notifications, super-node creation and tear-down requests and notifications, and voting requests and notifications.

The method is broken down into three main steps, connection authorization, request authorization followed by request result notification. Connection authorization is covered in the process described by step 180. During connection authorization, the sending peer-to-peer file system node 30 sends a request to a receiving peer-to-peer file system node 32. The first test in step 180 determines whether the sending peer-to-peer file system node 30 is allowed to connect or communicate with the receiving peer-to-peer file system node 32. The receiving peer-to-peer file system node 32 negotiates a connection and checks the sending peer-to-peer file system node 30 credentials using the privilege device 18. If the privilege device 18 authorizes the connection by the sending peer-to-peer file system node 30, the method proceeds to step 185. If the privilege device 18 does not authorize the connection by the sending peer-to-peer file system node 30, the method proceeds to step 190.

In step 185, a privileged operation is requested by the sending peer-to-peer file system node 30. The receiving peer-to-peer file system node 32 checks the sending peer-to-peer file system node 30 credentials using the privilege device 18 against the requested privileged operation. If the privilege device 18 authorizes execution of the privileged operation by the sending peer-to-peer file system node 30, then the method proceeds to step 195 if execution of the privileged operation was successful. If execution of the privileged operation was unsuccessful or execution was denied by the privilege device 19, then the method proceeds to step 190.

In step 190, either a connection was denied, a privileged operation was denied, or a privileged operation was unsuccessful. A failure notification can be optionally sent to the sending peer-to-peer file system node 30. The sending peer-to-peer file system node 30 may then notify the user that the requested operation failed. The user can be a computing device, program, or human being using the fault-tolerant peer-to-peer file system node 10 through a human-machine interface such as a computer terminal.

If both steps 185 and 190 are successful, then a success notification can be sent to the sending peer-to-peer file system node 30. The sending peer-to-peer file system node 30 may then notify the user that the requested operation succeeded. The user can be a computing device, program, or human being using the fault-tolerant peer-to-peer file system node 10 through a human-machine interface such as a computer terminal.

An example of FIG. 8 in practice would be the following connection and modification scenario, which uses a public key infrastructure, file modification permissions, and an access control list to provide the privilege device 18 functionality. A request to create a particular file is made by a sending peer-to-peer file system node 30. The file storage request is digitally signed using a public/private key infrastructure. All receiving storage server 15 nodes verify the digitally signed file storage request and reply to the sending peer-to-peer file system node 30 with digitally signed notifications for file storage availability. The sending peer-to-peer file system node 30 then contacts a selected storage server 15 and requests storage of a particular file. The storage server 15 then checks to ensure that the sending peer-to-peer file system node 30 is allowed to create files by checking an access control list on file for the sending peer-to-peer file system node 30. The storage server 15 then uses the sending peer-to-peer file system node 30 request to check to see if the node has the correct permissions to create the file at the given location.

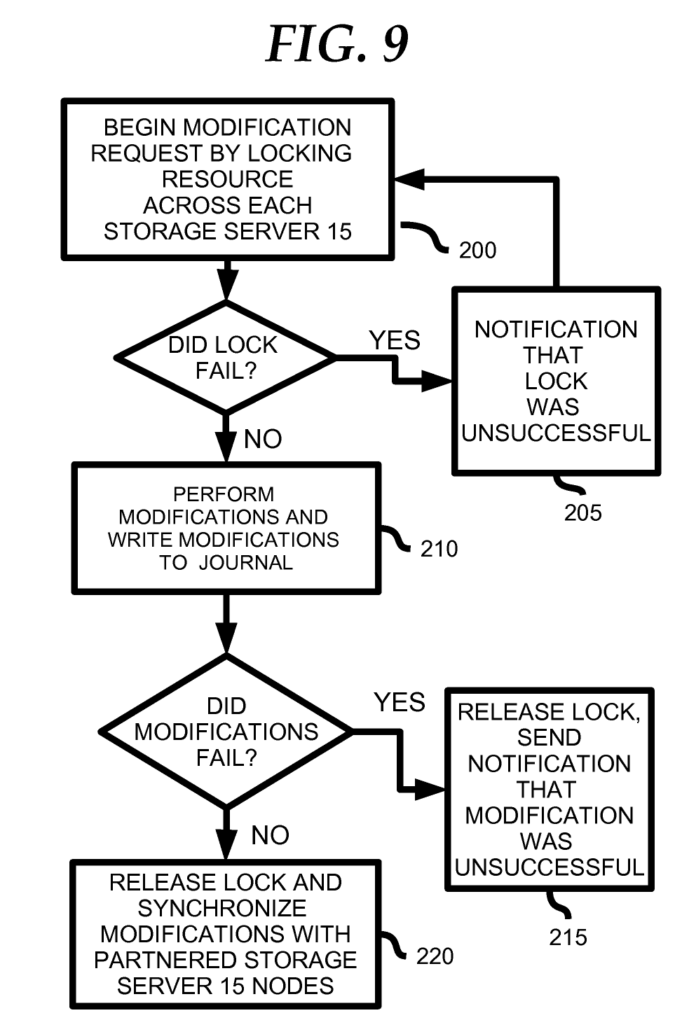

FIG. 9 outlines the method in which atomic modifications are made to resources in the highly-available clustered storage network 5. The method of modification must ensure dead-lock avoidance while ensuring atomic operation on the resources contained in the clustered storage network. Modifications can vary from simple meta-data updates to complex data file modifications. Dead-lock is avoided by providing a resource modification time-out such that if a resource is locked for modification, and a modification is not made within a period of time, for example five minutes, then the modification operation fails and the lock is automatically released.

As shown in step 200, a fault-tolerant peer-to-peer file system node 10 notifies the storage server 15 that a resource is going to be modified by sending a lock request to the storage server 15. In an embodiment of the invention, the lock request is accomplished by sending a unicast message via the communication network 20. The storage server 15 containing the resource replies with a lock request success notification.

The lock request can fail for numerous reasons, some of which are; the resource is already locked by another fault-tolerant peer-to-peer file system node 10, the resource is unavailable, locking the resource could create a dead-lock, or the resource that is to be locked does not exist. If the lock request fails, the fault-tolerant peer-to-peer file system node 10 is notified via step 205 by the storage server 15. If the fault-tolerant peer-to-peer file system node 10 so desires, it may retry the lock request immediately or after waiting for a specified amount of time.

For the lock request to be successful, all partnered storage server 15 nodes must successfully lock the resource. In one embodiment of the invention, this is accomplished by the first storage server 15 requesting a lock on the resource on behalf of the requesting fault-tolerant peer-to-peer file system node 10. Once all lock requests have been acknowledged, the first storage server 15 approves the lock request.

If the lock request is successful, the requesting fault-tolerant peer-to-peer file system node 10 is notified and the method continues to step 210. Once the resource is successfully locked, modifications can be performed to the resource. For example, if a file has been locked for modification—the file data can be modified by writing to the file data journal. Alternatively, a section of the file can be locked for modification to allow concurrent write access to the file data. If file meta-data has been locked, the meta-data can be modified.

If the modifications fail for any reason, the modifications are undone and the resource lock is released as shown in step 215. If the modifications fail, the requesting fault-tolerant peer-to-peer file system node 10 is notified.

If the modifications are successfully committed to the data file, the data file journal or the meta-data storage device, the next step is 220. Upon successful modification of the resource, the resource lock is released and the fault-tolerant peer-to-peer file system node 10 is notified. The modifications are then synchronized between the first storage server 15 and the partner storage server 15 nodes using the process outlined earlier in the document when discussing step 75.

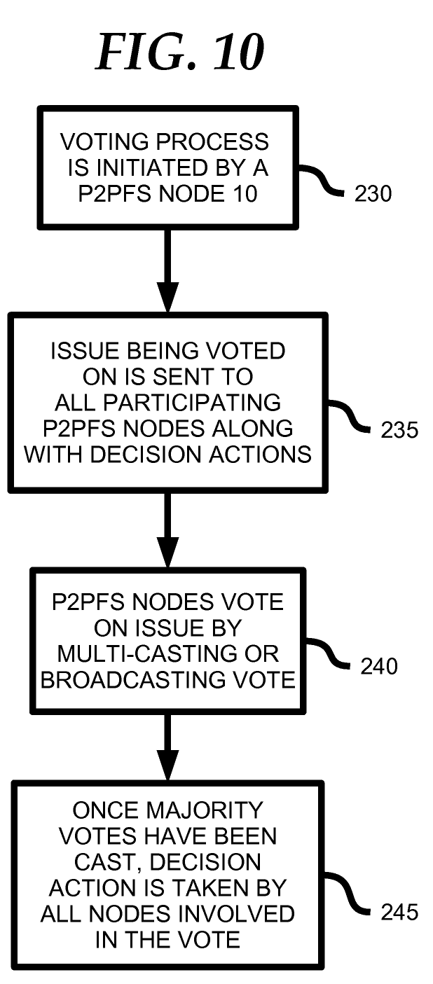

True peer-to-peer systems, by their very nature, do not have a central authority to drive the system. That means that there is no authority figure or single decision maker involved in the overall processing direction of the system. At times, for efficient system operation, it becomes necessary for the system to work together in processing data. It is beneficial if the system has a predetermined method of voting and decision execution based on all of the votes provided by the global peer-to-peer computing system. FIG. 10 outlines the method in which the highly-available clustered storage network 5 can vote on system-wide issues and provide a decision action based on the outcome of the vote.

Many issues can be voted on, some examples include; dynamic eviction of a problem node, dynamic creation of a resource authority, dynamic permission modification for a problem node, and dynamic invitation to rejoin the clustered file system for a previously evicted node.

In FIG. 10, step 230, a fault-tolerant peer-to-peer file system node 10 initiates the voting process by identifying an issue that needs a system vote and outlining the decision terms of the vote. The decision terms are the actions that should be taken if the vote succeeds or if the vote fails. For example, if a node on the network is misbehaving by flooding the network with bogus file storage requests another fault-tolerant peer-to-peer file system node 10 can initiate a vote to instruct the clustered storage network to ignore the misbehaving node. The decision action would be to ignore the misbehaving node if the vote succeeds, or to continue listening to the misbehaving node if the vote fails.

In step 235, the vote is initiated by broadcasting or multicasting a voting request message to each appropriate fault-tolerant peer-to-peer file system node 10. The vote is given a unique identifier such that multiple issues may be voted on simultaneously. The sub-set of fault-tolerant peer-to-peer file system node 10 objects then wait for a specified amount of time until the required number of votes is cast to make the vote succeed or fail. Each node may submit their vote as many times as they want to, but a vote is only counted once per issue voting cycle, per fault-tolerant peer-to-peer file system node 10.

In another embodiment of the invention, step 235 proceeds as described previously with the addition that a receiving fault tolerant peer-to-peer file system node 32 may notify the sub-set of fault-tolerant peer-to-peer file system node 10 objects that it intends to participate in the vote.

In step 240, each fault-tolerant peer-to-peer file system node 10 taking part in the vote casts their vote to the network by broadcasting or multicasting the voting reply message via the communication network 20. All nodes tally votes and each node sends a tally to all nodes participating in the voting. This ensures that a consensus is reached, only when consensus is reached do the nodes take the decision action stated in the preliminary voting request message as shown in step 245.

For example, the scenario of sending a voting request message to vote on evicting a problem node is used. The decision action is to ignore all communication from the problem node if the vote succeeds, or do nothing if the vote fails. If several nodes have noticed that the problem node is misbehaving, either by sending too much data that has resulted in no relevant work being performed or sending too many requests for the same data, which is a sign of a denial of service attack, then those nodes would vote to evict the node. Rules are predetermined per node via a configuration information provided at node start-up. The rules for node eviction state that only 10% of the participating nodes, or at least two nodes, whichever is greater, must agree for node eviction. If 2 out of 10 nodes vote for node eviction, which matches both eviction rules—at least 10% or at least 2 nodes voting to evict, all nodes stop communicating with the evicted node.

When performing certain tasks, such as queries or file data locking, it is far better to perform them in a traditional client-server model as opposed to a more complex peer-to-peer model. One of the main reasons that this is the case is that on any truly peer-to-peer network, most of the time is spent finding the resource that is needed rather than reading or modifying the resource. The speed of the modifications can be improved by removing the step of finding the resource, or constraining the search to a limited series of nodes. This is the case when storage networks grow to hundreds, thousands, or tens of thousands of nodes operating in a clustered storage network. It is far more efficient from a time and bandwidth resource perspective to start centralizing commonly used information and meta-data.

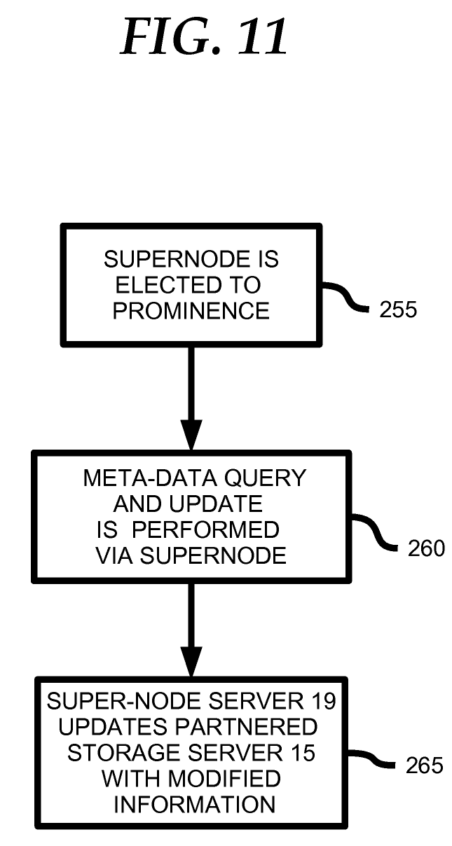

FIG. 11 illustrates the method of creating less decentralized information and/or meta-data repositories. For purposes of the explanation, a less decentralized information and/or meta-data repository is referred to as a super-node server 19. A super-node server 19 is not required for proper operation of the fault-tolerant peer-to-peer storage system 5, but it may help performance by having a plurality of specialized nodes once the storage cluster reaches a certain size. The process of creating a super-node server 19 utilizes the method outlined in FIG. 10 for voting for certain issues relating to the clustered storage network.

As shown in step 255, any fault-tolerant peer-to-peer file system node 10 may ask each storage node 15 on the highly-available clustered storage network 5 to elect it as a super-node server 19. A voting mechanism, as the one described in FIG. 10, is used to see if the other nodes want the requesting node to be elected as a super-node server 19. If the vote is successful, the requesting node is elected to super-node server 19 status and it notifies the network that particular resource accesses should be done via the super-node server 19. If any fault-tolerant peer-to-peer file system node 10 requests a resource via a broadcast or multicast message, and a super-node server 19 is capable of answering the request, then the super-node server 19 answers the request and also notifies the sending fault-tolerant peer-to-peer file system node 10 that it is the authority for the given resource. A super-node server 19 does not need to provide less decentralized information and/or meta-data services for all of the resources on the clustered storage network, it may choose to only manage resources that are in the most demand.

After election to super-node server 19 status, modification of information and meta-data resources that the super-node server 19 has claimed it is responsible for are performed via the super-node server 19 as shown in step 260. The method of locking a resource, modifying the resource, and unlocking the resource are described in FIG. 9. The method of locking, modifying and unlocking are the same in the super-node server 19 scenario except that the modification of the data happens on the super-node server 19 and is then propagated to the storage server 15 after the operation is deemed successful on the super-node server 19 as shown in step 265.

An example of a super-node server 19 in action is a scenario having to do with querying a resource and modifying that resource. For the example scenario, it is already assumed that the super-node server 19 has been elected to prominence and that it has voluntarily stated that it will manage access to the meta-data information regarding access permissions for a particular file data resource. For optimizations sake, permanent network connections are created between each storage server 15 node and the super-node server 19. Any updates committed to the super-node server 19 are immediately propagated to each storage server 15 that the modification affects. Any resource query will always go to each super-node server 19 via a unicast or multicast message and then proceed to the entire clustered storage network if the super-node server 19 is not aware of the resource.

For example, a file data permissions query will go directly via a unicast network link to the super-node server 19, which will respond by stating the file permissions for the particular resource. A file lock can also occur by the requesting node requesting a file lock on the super-node server 19, the file lock being propagated to the storage server 15, the file lock being granted to the requesting node, the requesting node contacting the storage server 15 to modify the file, and then unlocking the file on the super-node server 15, which would propagate the change to the storage server 15.

A super-node may disappear at any point during network operation and not affect regular operation of the clustered storage network. If an operational super-node server 19 fails for any reason, the rest of the nodes on the network fall back to the method of communication and operation described previously, in FIGS. 1 through 10, in the present invention.

A super-node may also opt to de-list itself as a super-node. To accomplish this, a message is sent to the storage network notifying each participant that the super-node is de-listing itself as a super-node. Voting participants on the network may also vote to have the super-node de-listed from the network if one is no longer necessary or available.

While there have been many variations of high-availability file systems, fault-tolerant file systems, redundant file systems, network file systems and clustered file systems, the present invention is superior for the following reasons:
The present invention does not require a centralized meta-data server for proper operation of the file storage network.
The present invention does not require any configuration information regarding every participant in the clustered storage network.
The present invention allows failure of all but one storage server 15 in the network and will continue to operate in a degraded mode until required failed storage servers rejoin.
The present invention automatically extends the available storage of a clustered file system when another node joins.
The present invention automatically provides high-availability and fault-tolerance during node failure without any further configuration.
Storage is only limited by the number of disks that you can allocate to the file system—it is truly scalable.
The present invention allows auto-discovery of all clustered file system resources without any prior configuration.
The present invention includes fault-tolerance, high-availability, auto-discovery and a distributed method of access via a distributed group of permissions.
A cascading peer-to-peer based locking and unlocking scheme.
Data is encrypted and digitally signed from end to end regardless of the knowledge of late joiners to the clustered storage network.
A method of voting for clustered storage network actions is available for decisions that cannot be made by one node.
A method for optimization of the system is described via super-node servers that can join and leave the network without affecting the availability of the clustered storage network.

Although described with reference to a preferred embodiment of the invention, it should be readily understood that various changes and/or modification can be made to the invention without departing from the spirit thereof. While this description concerns a detailed, complete system, it employs many inventive concepts, each of which is believed patentable apart from the system as a whole. The use of sequential numbering to distinguish the methods employed is used for descriptive purposes only, and is not meant to imply that a user must proceed from one step to another in a serial or linear manner. In general, the invention is only intended to be limited by the scope of the following claims.

1. A computing system comprising:
a plurality of storage servers coupled with long-term storage devices;
a communication network;
a plurality of storage clients;
each storage server adapted to communicate via unicast, broadcast or multicast;
each storage server further adapted to store files on a long term basis and process file system requests by the storage client;
each storage server further adapted to asynchronously join and leave the communication network;
each storage server further adapted to automatically mirror files to at least one other storage server such that at least one complete copy of a file remains when a storage server permanently disconnects from the network;
each storage server further adapted to gracefully degrade the file system and provide availability with up to N-(N−1) system failures;
and each storage server further adapted to use a distributed meta-data storage system.

2. The system of claim 1, further comprising: a super-node server.

3. The system of claim 1, further comprising: a privilege device.

4. The system of claim 1, wherein any data stored on the network is stored on at least two different storage servers.

5. The system of claim 4, wherein if one of the two storage servers leaves the network for an extended period of time, the remaining storage server partners with another storage server on the network to mirror the data.

6. The system of claim 5, wherein when a storage server returns to the network, it synchronizes all of the information, meta-data and data files with the up-to-date storage servers.

7. The system of claim 1, wherein any storage client may perform file storage without needing to perform the operation through a central authority.

8. The system of claim 1, wherein any storage client may perform resource queries via the communication network without needing to perform the operation through a central authority.

9. The system of claim 1, wherein any file retrieval may be performed by retrieving the file from a plurality of locations.

10. The system of claim 1, wherein any information or meta-data query may be performed in a distributed, non-centralized manner.

11. The system of claim 3, wherein the privilege device is used to authenticate connections between storage servers, storage clients and super-node servers.

12. The system of claim 1, wherein any modification to information, meta-data, or a data file requires locking the resource before performing the modification.

13. The system of claim 12, wherein any modification to file data may be written to a file journal to speed synchronization between storage servers.

14. The system of claim 1, wherein a method of voting on cluster-wide resources and issues is provided such that any participant in the network may initiate a vote, decision actions are provided for the vote, and every participant that the vote affects votes to determine the decision of the network as a whole.

15. The system of claim 2 and claim 14, wherein elections of regular participants in the network are made to make their super-node servers take responsibility for access and modification of certain meta-data to lower operational latency on the file system.

16. The system of claim 15, wherein meta-data modified via the super-node is synchronized to permanent storage servers and vice-versa.

17. A method for utilizing a computer system and network for the highly-available, fault-tolerant, storage of file data comprising:
pairing a storage server in the network with a long-term storage device;
designating a method of communication via the network that includes unicast, multicast and broadcast messaging;
designating at least one storage client to access the storage servers to store and retrieve file data;
querying the storage servers for information without relying on a central authority or super-nodes;
immediately mirroring information, meta-data and file data between at least two storage servers in the network when possible;

18. The method of claim 17, further comprising: synchronizing data between an out-of-date storage server that has previously left the network or fallen out of sync and an up-to-date storage server.

19. The method of claim 17, further comprising: synchronizing data between an out-of-date storage server this is currently connected to the network and a up-to-date storage server that is going to leave the network.

20. The method of claim 17, further comprising: performing file storage on the network without the aid of a central authority.

21. The method of claim 17, further comprising: performing a resource query on the network without the need for a central authority.

22. The method of claim 17, further comprising: retrieving a resource from the network without the direction of a central authority and downloading the resource from multiple up-to-date sources.

23. The method of claim 17, further comprising: performing a information or meta-data query on the network without the need for a central authority.

24. The method of claim 17, further comprising: authorizing connections by using a privilege device to ensure authorized connections.

25. The method of claim 24, further comprising: utilizing the privilege device to authorize specific file system operations by storage clients.

26. The method of claim 17, further comprising: modifying information, meta-data or file data without the need for a central authority.

27. The method of claim 17, further comprising: writing modifications to a file journal to aid in synchronization speed between partnered storage servers.

28. The method of claim 17, further comprising: voting on cluster-wide resources and issues such that any participant in the network may initiate a vote, provide decision actions for the vote, and ensuring that every participant that the vote affects votes to determine the decision of the network as a whole.

29. The method of claim 28, further comprising: electing a regular participant in the network to super-node status, which will provide a less decentralized authority for a particular set of resources on the network.

30. The method of claim 29, further comprising: modifications to resources may be made via a super-node and propagated to the partnered storage node on which they belong.
